(19) United States
(12) Patent Application Publication
(10) Pub. No.: US 2023/0013708 A1
(43) Pub. Date: Jan. 19, 2023

(54) APPARATUS AND METHOD FOR PREDICTING TELEWORK EFFECT,AND NON-TRANSITORY COMPUTER READABLE MEDIUM STORING PROGRAM

(71) Applicant: NEC Corporation, Minato-ku Tokyo (JP)

(72) Inventor: Hirotake SATO, Tokyo (JP)

(73) Assignee: NEC Corporation, Minato-ku Tokyo (JP)

(21) Appl. No.: 17/782,790

(22) PCT Filed: Dec. 10, 2019
(86) PCT No.: PCT/JP2019/048525

§ 371 Date: Jun. 6, 2022

(51) Int. Cl. G06Q 10/06

(52) U.S. Cl. CPC G06Q 10/06398; G06Q 10/06393

(57) ABSTRACT

A telework effect prediction apparatus (100) includes a storage unit (110) for storing a telework effect prediction model (111) for predicting a degree of effectiveness of teleworking based on a congestion degree of a commuting route and a cooperative work amount of a user, an acquisition unit (120) for acquiring a predicted value of the congestion degree of the commuting route of a specific user on a designated date, a calculation unit (130) for calculating a cooperative work amount from a work schedule of the specific user on the designated date, a prediction unit (140) for predicting the degree of effectiveness of the teleworking from the acquired predicted value and the calculated cooperative work amount by using the telework effect prediction model; and an output unit (150) for outputting information based on the predicted degree of effectiveness.

### TECHNICAL FIELD

The present disclosure relates to an apparatus, a method, and a program for telework effect prediction, and more particularly to an apparatus, a method, and a program for telework effect prediction in order to predict an effect of teleworking.

### BACKGROUND ART

The congestion of transportation during commuting has become a social problem, because it may cause accidents to occur and a problem in the operation of large-scale events. Thus, the elimination of the congestion is desired. It is expected that teleworking will be means for easing congestion of transportation. Teleworking refers to a flexible work style in which a worker uses ICT (Information and Communication Technology) and is not bound by time or place. Examples of teleworking include working from home, mobile working, and working at a satellite office.

Patent Literature 1 discloses a technique for calculating a teleworking population by region. The technique described in Patent Literature 1 uses a database of the telework population in a certain year and in a certain region to calculate the telework population in regions other than the certain region by performing regression analysis on years other than the certain year and regions other than the certain region.

Patent Literature 2 discloses a technique for statistically calculating prediction data of a congestion rate of each vehicle in each unit time at each station for each weekday, holiday, and the kind of weather.

### CITATION LIST

### Patent Literature

Patent Literature 1: Japanese Unexamined Patent Application Publication No. 2018-156307
Patent Literature 2: Japanese Unexamined Patent Application Publication No.

2012-174025

### SUMMARY OF INVENTION

### Technical Problem

By teleworking during normal commuting hours and commuting at staggered work hours, it is expected that traffic congestion can be eased. On the other hand, teleworking may not be appropriate even when transportation is expected to be congested such as when there is work that requires a worker to be at an office. As described above, whether or not teleworking is effective for an individual is influenced by various factors. However, there has been no index available to quantitatively determine the effect of teleworking for each individual in which these factors are taken into consideration.

An object of the present disclosure is to provide telework effect prediction apparatus, method, and program for presenting an index for quantitatively determining an effect of teleworking on an individual basis.

### Solution to Problem

In a first example aspect of the present disclosure, a telework effect prediction apparatus includes:

storage means for storing a telework effect prediction model for predicting a degree of effectiveness of teleworking based on a congestion degree of a commuting route and a cooperative work amount of a user;

acquisition means for acquiring a predicted value of the congestion degree of the commuting route of a specific user on a designated date;

calculation means for calculating a cooperative work amount from a work schedule of the specific user on the designated date;

prediction means for predicting the degree of effectiveness of the teleworking from the acquired predicted value and the calculated cooperative work amount by using the telework effect prediction model; and

output means for outputting information based on the predicted degree of effectiveness.

In a second example aspect of the present disclosure, a telework effect prediction method performed by a computer includes:

acquiring a predicted value of a congestion degree of a commuting route of a specific user on a designated date;

calculation means for calculating a cooperative work amount from a work schedule of the specific user on the designated date;

predicting a degree of effectiveness of teleworking from the acquired predicted value and the calculated cooperative work amount by using a telework effect prediction model for predicting the degree of effectiveness of the teleworking based on the congestion degree of the commuting route and the cooperative work amount of a user; and

outputting information based on the predicted degree of effectiveness.

In a third example aspect of the present disclosure, a telework effect prediction program causes a computer to execute:

processing of acquiring a predicted value of a congestion degree of a commuting route of a specific user on a designated date;

processing of calculation means for calculating a cooperative work amount from a work schedule of the specific user on the designated date;

processing of predicting a degree of effectiveness of teleworking from the acquired predicted value and the calculated cooperative work amount by using a telework effect prediction model for predicting the degree of effectiveness of the teleworking based on the congestion degree of the commuting route and the cooperative work amount of a user; and

processing of outputting information based on the predicted degree of effectiveness.

### Advantageous Effects of Invention

According to the present disclosure, it is possible to provide a telework effect prediction apparatus, method, and program for presenting an index for quantitatively determining an effect of teleworking on an individual basis.

### BRIEF DESCRIPTION OF DRAWINGS

FIG. 1 is a block diagram showing a configuration of a telework effect prediction apparatus according to a first example embodiment;

FIG. 2 is a flowchart showing a flow of a telework effect prediction method according to the first example embodiment;

FIG. 3 is a block diagram showing an overall configuration including a telework effect prediction system according to a second example embodiment;

FIG. 4 is a block diagram showing a configuration of a telework effect prediction system according to the second example embodiment;

FIG. 5 is a flowchart showing a flow of learning processing of a telework effect prediction model according to the second example embodiment;

FIG. 6 shows an example of learning data according to the second example embodiment;

FIG. 7 shows an example of the learning data according to the second example embodiment;

FIG. 8 shows an example of the learning data according to the second example embodiment;

FIG. 9 shows an example of multiple regression parameters according to the second example embodiment;

FIG. 10 is a flowchart showing a flow of a telework effect prediction method according to the second example embodiment;

FIG. 11 is a flowchart showing a flow of congestion degree specifying processing according to the second example embodiment;

FIG. 12 is a diagram for explaining a concept of specifying a congestion degree according to the second example embodiment;

FIG. 13 is a flowchart showing a flow of cooperative work amount calculation processing according to the second example embodiment;

FIG. 14 is a diagram for explaining a concept of the cooperative work amount calculation according to the second example embodiment;

FIG. 15 shows an example of a prediction result (degree of effectiveness) based on the congestion degree and a workload according to the second example embodiment;

FIG. 16 shows an example of a graph display of the congestion degree, the workload, and the prediction result (degree of effectiveness) according to the second example embodiment;

FIG. 17 is a flowchart showing a flow of processing for outputting a determination result according to the second example embodiment;

FIG. 18 is a flowchart showing a flow of a telework effect prediction method according to a third example embodiment;

FIG. 19 is a block diagram showing a configuration of a telework effect prediction system according to a fourth example embodiment; and

FIG. 20 is a flowchart showing a flow of teleconference setting processing according to the fourth example embodiment.

### DESCRIPTION OF EMBODIMENTS

Hereinafter, example embodiments of the present disclosure will be described in detail with reference to the drawings. In each drawing, the same or corresponding elements are denoted by the same reference signs, and repeated descriptions are omitted as necessary for clarity of description.

### First Example Embodiment

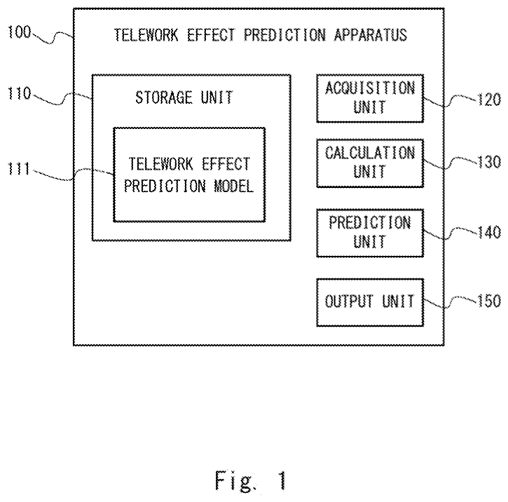

FIG. 1 is a block diagram showing a configuration of a telework effect prediction apparatus 100 according to a first example embodiment. The telework effect prediction apparatus 100 is an information processing apparatus for predicting a degree of effectiveness of teleworking. The telework effect prediction apparatus 100 includes a storage unit 110, an acquisition unit 120, a calculation unit 130, a prediction unit 140, and an output unit 150.

The storage unit 110 is an example of storage means, and stores at least a telework effect prediction model 111. The telework effect prediction model 111 is a program module or an AI (Artificial Intelligence) model in which a logic for predicting the degree of effectiveness of teleworking based on a congestion degree of a commuting route and a cooperative work amount of a user is implemented.

The acquisition unit 120 is an example of acquisition means, and acquires a predicted value of the congestion degree of the commuting route of a specific user on a designated date. Here, the congestion degree is a value indicating the congestion degree of a vehicle in a predetermined section (e.g., a section between stations) on the commuting route when the user uses public transportation. For example, the congestion degree may be a congestion rate or a vehicle occupancy of a train or a bus, or a value obtained by normalizing the congestion rate. The acquisition unit 120 acquires a predicted value of the congestion degree by an input from a known external system for predicting congestion degrees or from a user.

The calculation unit 130 is an example of calculation means, and calculates a cooperative work amount from a work schedule of a specific user on a designated date. The work schedule includes information in which a type (content) of a task set for the specific user, a scheduled start time, and a scheduled end time are associated with each other. The cooperative work amount is data indicating the number of tasks (cooperative work tasks) to be performed jointly with other users among tasks of the specific user, the time required for the cooperative work task, and the like.

The prediction unit 140 is an example of prediction means, and predicts the degree of effectiveness of teleworking from the acquired predicted value and the calculated cooperative work amount by using the telework effect prediction model 111. Here, the degree of effectiveness of teleworking is a degree or an index value indicating how much progress is carrying out the task is made when the user teleworks. The output unit 150 is an example of output means, and outputs information based on the predicted degree of effectiveness. The “information based on the degree of effectiveness” may be the degree of effectiveness itself, or data obtained by making the degree of effectiveness subject to a predetermined conversion or processing. The output unit 150 may output information based on the degree of effectiveness to an external device, such as a user terminal, by using a display device or a communication line connected to the telework effect prediction apparatus 100.

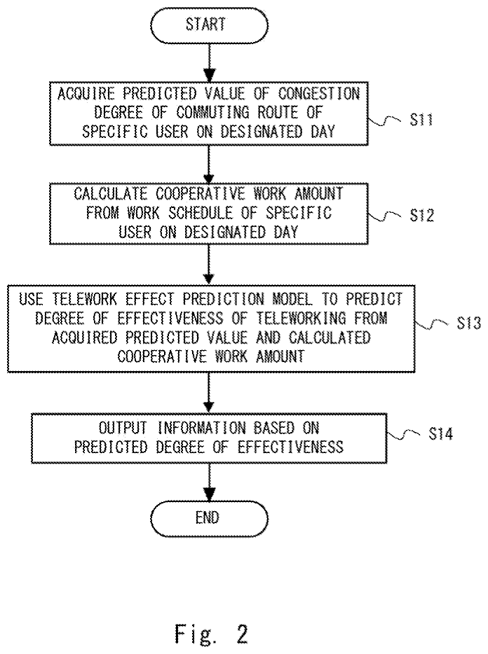

FIG. 2 is a flowchart showing a flow of a telework effect prediction method according to the first example embodiment. It is assumed that the telework effect prediction apparatus 100 has received a designation of a date (designated date) on which a prediction is to be made and an input of identification information of a specific user or the like from the outside by an input of a user or the like.

First, the acquisition unit 120 acquires a predicted value of the congestion degree of the commuting route of the specific user on the designated date (S11). Next, the calculation unit 130 calculates the cooperative work amount from the work schedule of the specific user on the designated date (S12). The processing order of Steps S11 and S12 may be reversed, or Steps S11 and S12 may be processed in parallel.

Next, the prediction unit 140 uses the telework effect prediction model 111 to predict the degree of effectiveness of teleworking from the predicted value acquired in Step S11 and the cooperative work amount calculated in Step S12 (Step S13). For example, the prediction unit 140 inputs the acquired predicted value and the calculated cooperative work amount to the telework effect prediction model 111, and acquires the degree of effectiveness of teleworking as an output result so as to predict the degree of effectiveness. Then, the output unit 150 outputs information based on the predicted degree of effectiveness (S14).

As mentioned above, it has not been possible to provide a basis for quantitatively determining whether teleworking is effective in easing traffic congestion in commuting hours by comparing work states with congestion states in commuting hours. On the other hand, this example embodiment can present an index for quantitatively determining the effect of teleworking on an individual basis.

Note that the telework effect prediction apparatus 100 includes a processor, a memory and a storage device (not shown). A computer program in which the processing of the telework effect prediction method according to this example embodiment is implemented is stored in the storage device. The processor reads the computer program from the storage device into the memory and executes the computer program. In this way, the processor implements the functions of the acquisition unit 120, the calculation unit 130, the prediction unit 140, and the output unit 150.

Alternatively, each of the acquisition unit 120, the calculation unit 130, the prediction unit 140, and the output unit 150 may be implemented by dedicated hardware. Further, some or all of the constituent elements of each device may be implemented by general-purpose or dedicated circuitry, processors, etc., or a combination thereof. These constituent elements may be composed of a single chip or a plurality of chips connected via a bus. Some or all of the constituent elements of each device may be implemented by a combination of the circuitry, the program, and the like described above. The processor may be a CPU (Central Processing Unit), a GPU (Graphics Processing Unit), an FPGA (field-programmable gate array), or the like.

Further, when some or all of the constituent elements of the telework effect prediction apparatus 100 are implemented by a plurality of information processing apparatuses, circuitry, etc., the plurality of information processing apparatuses, circuitry, and the like, may be collectively arranged or arranged separate from each other. For example, the information processing apparatus, the circuitry, and the like may be implemented as a form where they are connected to each other via a communication network, such as a client server system, a cloud computing system, and the like. Further, the function of the telework effect prediction apparatus 100 may be provided in a SaaS (Software as a Service) format.

### Second Example Embodiment

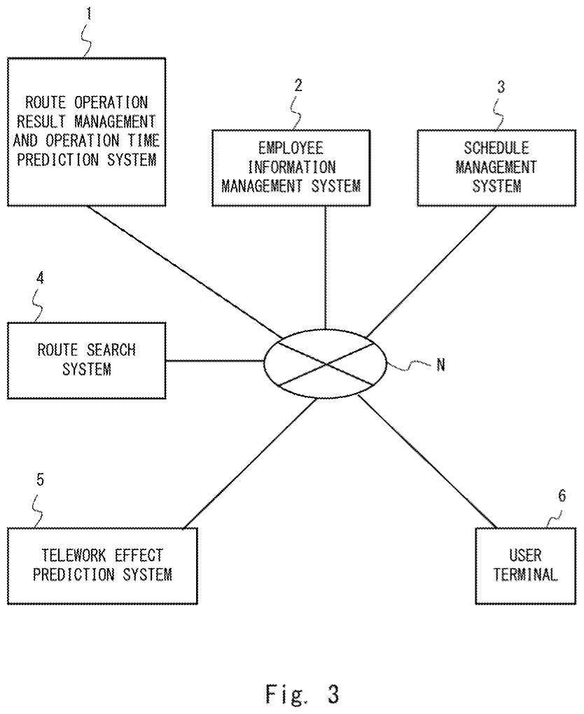

A second example embodiment is a specific example of the first example embodiment described above. FIG. 3 is a block diagram showing an overall configuration including a telework effect prediction system 5 according to the second example embodiment. A route operation result management and operation time prediction system 1, an employee information management system 2, a schedule management system 3, a route search system 4, a telework effect prediction system 5, and a user terminal 6 are connected to each other via a network N.

The route operation result management and operation time prediction system 1 is an information system for managing operation performance of routes in public transportation and predicting operation times. The route operation result management and operation time prediction system 1 can be implemented by a known information system operated by a specific public transportation system or an enterprise other than the public transportation system. When an input of a designated date and a (commuting) route is received from an external system (e.g., the telework effect prediction system 5) via the network N, the route operation result management and operation time prediction system 1 calculates a congestion rate of the commuting route and returns the calculated congestion rate via the network N. Here, the congestion rate is the vehicle occupancy of each vehicle in each section between stations. The congestion rate is an average of the congestion rates of a plurality of vehicles. When the accepted designated date is a future date (if the designated date is the current day, a future time), the route operation result management and operation time prediction system 1 predicts the congestion rate and returns the predicted value of the congestion rate. The processing for predicting the congestion rate is performed by using a general prediction algorithm based on the history of the congestion rate in the past. For example, the technique described in Patent Literature 2 may be employed.

The employee information management system 2 is an information system for managing employee information in an enterprise to which a user, for which the degree of effectiveness of telework in this example embodiment is to be predicted (such a user is hereinafter referred to as a prediction target user) belongs. The employee information includes information about the commuting route (hereinafter referred to as “commuting route information”) associated with the identification information of each employee (user). Here, the commuting route information includes a nearest station to the home (departure station), a nearest station to a workplace (arrival station), and a transit (transfer) station. That is, the employee information management system 2 includes a database system for the employee information. The employee information management system 2 receives a request for information about the commuting route including the identification information (user ID, etc.) of the user from the telework effect prediction system 5 or the user terminal 6 via the network N. In this case, the employee information management system 2 specifies the commuting route information associated with the user ID from the database, and returns the specified commuting route information to a request source via the network N.

The schedule management system 3 is an information system for managing the work schedule (work plan) of each employee in the enterprise to which the prediction target user belongs. The work schedule includes a daily task list associated with the identification information of the user. Each task included in the task list is associated with identification information of the task (task ID), a task type or a content, a scheduled work start time, and a scheduled work end time. That is, the schedule management system 3 includes a work schedule database system. The schedule management system 3 receives a request for the task list including the user ID and the like from the telework effect prediction system 5 or the user terminal 6 via the network N. In this case, the schedule management system 3 specifies the task list associated with the user ID from the database, and returns the specified task list to the request source via the network N.

The route search system 4 is an information system for searching a route of a transportation. The route search system 4 receives a search request including a departure station and an arrival station from the user terminal 6 or the like via the network N, and returns a search result of route information of the transportation to a request source. The route search system 4 may perform search in cooperation with the route operation result management and operation time prediction system 1.

The user terminal 6 is a terminal apparatus operated by the prediction target user or a user who is related to the prediction target user. The user terminal 6 is, for example, a personal computer, a smartphone, a tablet terminal, or the like. The user terminal 6 accesses the employee information management system 2, the schedule management system 3, the route search system 4, or the telework effect prediction system 5 via the network N according to the operation of the user. Then, the user terminal 6 receives a response result from each system via the network N, and displays it on the screen or the like. In particular, in this example embodiment, the user terminal 6 transmits a request for predicting the effect of teleworking including the identification information of the prediction target user (specific user) to the telework effect prediction system 5 via the network N in response to an input from the user. The user terminal 6 receives information based on the degree of effectiveness predicted from the telework effect prediction system 5 via the network N and displays the information on the screen.

The telework effect prediction system 5 is an example of the telework effect prediction apparatus 100 described above, and is an information system for predicting the degree of effectiveness of teleworking. The telework effect prediction system 5 receives the request for predicting the effect of teleworking from the user terminal 6 via the network N. In response to the prediction request, the telework effect prediction system 5 acquires the commuting route, the congestion rate, and the task list as appropriate from the route operation result management and operation time prediction system 1, the employee information management system 2, and the schedule management system 3. The telework effect prediction system 5 specifies the congestion degree from the congestion rate, and calculates the cooperative work amount from the task list. Next, the telework effect prediction system 5 inputs the congestion degree and the cooperative work amount into a telework effect prediction model, which will be described later, and acquires the degree of effectiveness to predict the degree of effectiveness. After that, the telework effect prediction system 5 transmits information based on the predicted degree of effectiveness to the user terminal 6 via the network N.

The telework effect prediction system 5 functions as a learning apparatus of the telework effect prediction model. The telework effect prediction system 5 acquires input data for machine learning from the route operation result management and operation time prediction system 1, the employee information management system 2, and the schedule management system 3 via the network N. The telework effect prediction system 5 acquires a questionnaire result which is based on an evaluation by the user who actually teleworked of the degree of effectiveness of teleworking on a teleworked date and makes the questionnaire result ground truth data for machine learning. The telework effect prediction system 5 learns a telework effect prediction model by using learning data (input data and ground truth data) and updates it to optimum parameters.

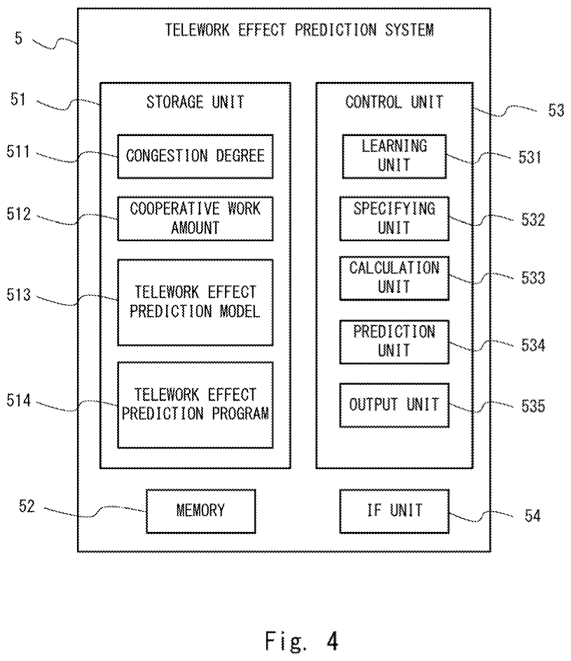

FIG. 4 is a block diagram showing a configuration of the telework effect prediction system 5 according to the second example embodiment. The telework effect prediction system 5 schematically shows a part of a hardware configuration when implemented by one computer device. The telework effect prediction system 5 may be made redundant by two or more computer devices, or may be implemented by distributing functions to a plurality of computer apparatuses.

The telework effect prediction system 5 includes a storage unit 51, a memory 52, a control unit 53, and an IF (Interface) unit 54. The storage unit 51 is an example of the storage unit 110 described above, and is a storage device such as a hard disk or a flash memory. The storage unit 51 stores at least a congestion degree 511, a cooperative work amount 512, a telework effect prediction model 513, and a telework effect prediction program 514.

The congestion degree 511 is a value obtained by normalizing the maximum congestion rate for each time slot, which the maximum congestion rate is selected from among the congestion rates obtained in sections when the commuting route is divided into a plurality of sections. The cooperative work amount 512 is a work amount corresponding to cooperative work among tasks set in a specific time slot (the number of overlapping cooperative work tasks set).

The telework effect prediction model 513 is an example of the telework effect prediction model 111 described above. The telework effect prediction model 513 is a model that quantifies a relationship between a congestion degree in commuting hours, a work state, and an effect of teleworking. The telework effect prediction model 513 is a learned model in which (normalized values) of the congestion degree 511 and the cooperative work amount 512 are input and the degree of effectiveness of teleworking is output. The telework effect prediction model 513 can be implemented by multiple regression analysis, a support vector machine, a neural network, or the like. The learning processing will be described later.

The telework effect prediction program 514 is a computer program in which the telework effect prediction method according to this example embodiment is implemented.

The memory 52 is a volatile storage device such as a Random Access Memory (RAM), and is a storage area for temporarily holding information during the operation of the control unit 53. The IF unit 54 is an interface for performing input from and output to the outside of the telework effect prediction system 5. For example, the IF unit 54 outputs the prediction request received via the network N to the control unit 53, and transmits the prediction result or the like to the request source via the network N.

The control unit 53 is a processor or control unit for controlling each component of the telework effect prediction system 5. The control unit 53 reads the telework effect prediction program 514 from the storage unit 51 into the memory 52 and executes the telework effect prediction program 514. In this way, the control unit 53 implements the functions of the learning unit 531, the specifying unit 532, the calculation unit 533, the prediction unit 534, and the output unit 535. The specifying unit 532 is an example of the acquisition unit 120, the calculation unit 533 is an example of the calculation unit 130, the prediction unit 534 is an example of the prediction unit 140, and the output unit 535 is an example of the output unit 150.

The learning unit 531 is an example of learning means, and learns the telework effect prediction model 513. In this case, the learning unit 531 uses the past congestion rates in each of the commuting routes of the plurality of users and the cooperative work amounts in the past working days of the respective users as input data for machine learning. The learning unit 531 uses evaluation information about the degree of effectiveness of teleworking on this working day by each user as ground truth data for machine learning. Here, the normalized congestion degree 511 may be used as the input data instead of the past congestion rate. The input data may be a value obtained by normalizing the cooperative work amount (this value is hereinafter referred to as a “workload”) instead of the cooperative work amount. The term “evaluation information of the degree of effectiveness about teleworking” means that a questionnaire is given to each user and the user numerically evaluates the degree of effectiveness. The evaluation information may be, for example, a result of evaluating a day on which the user teleworked and a day on which the user did not telework on a scale of 10 by using the same evaluation criteria. The evaluation information may indicate such that, for example, the closer an evaluation value is to 0, the lower the effect is, whereas the closer the evaluation value is to 10, the higher the effect is. The evaluation information may be an average value of evaluation values obtained from a plurality of users using the same commuting route. Thus, a model with high prediction accuracy can be generated.

In this example embodiment, the learning unit 531 is not indispensable. For example, the telework effect prediction system 5 may store, in the storage unit 51, the telework effect prediction model 513 that has been learned outside the telework effect prediction system 5 in advance. The learning unit 531 may be provided in an information processing apparatus different from the telework effect prediction system 5.

In response to a prediction request from the user terminal 6, the specifying unit 532 acquires congestion rates in each section between stations along the commuting route of the specific user on the designated date, smoothes the congestion rates in the section between stations for each time slot, and specifies the maximum congestion rate. The specifying unit 532 specifies the congestion rate as a congestion degree by normalizing the congestion rate.

The calculation unit 533 acquires the task list of the specific user on the designated date in response to the prediction request from the user terminal 6, and classifies each task into either individual work or cooperative work. The calculation unit 533 calculates a degree of overlap of the tasks classified as the cooperative work in the scheduled execution time slots, normalizes the degree of overlap to calculate it as the workload (of the cooperative work).

The prediction unit 534 inputs the specified congestion degree and the calculated workload to the telework effect prediction model 513, and acquires the output result as the degree of effectiveness of teleworking in order to predict it.

The output unit 535 outputs a determination result for the degree of effectiveness predicted by the prediction unit 534. Here, the output unit 535 may determine that the teleworking is effective when the degree of effectiveness exceeds a threshold, and may determine that the teleworking is not effective when the degree of effectiveness is equal to or less than the threshold. The output unit 535 may output the degree of effectiveness for each time slot. For example, the output unit 535 may output to the user terminal 6 so that the degree of effectiveness is graphically displayed along the time axis. That is, the output unit 535 may output information corresponding to the time slot on the designated date and based on the predicted degree of effectiveness.

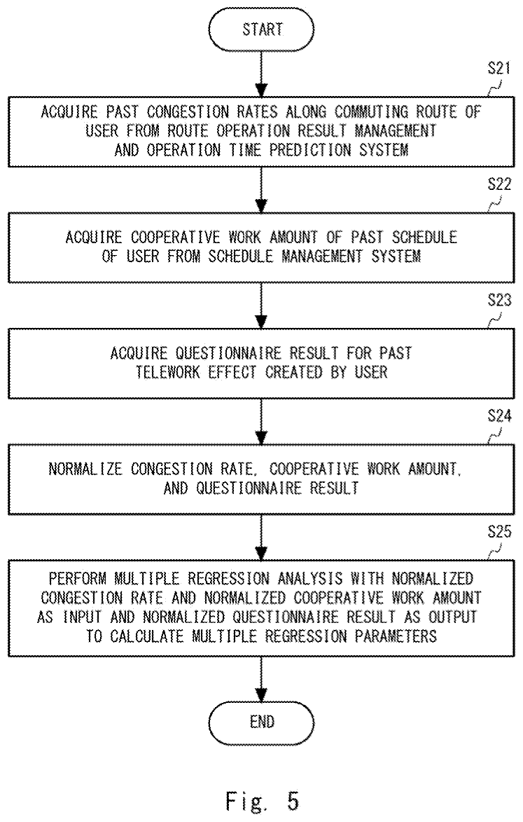

FIG. 5 is a flowchart showing a flow of the processing for learning the telework effect prediction model according to the second example embodiment. First, the learning unit 531 acquires past congestion rates along (one or more) commuting routes of a predetermined user from the route operation result management and operation time prediction system 1 (S21). Specifically, the learning unit 531 transmits a request for acquiring the past congestion rates along the predetermined (one or more) commuting routes to the route operation result management and operation time prediction system 1 via the network N. The route operation result management and operation time prediction system 1 acquires the congestion rates in a plurality of time slots along the predetermined commuting route from history of the congestion rates in the past in response to the acquisition request, and returns the acquired congestion rates to the telework effect prediction system 5.

Next, the learning unit 531 acquires (one or more) cooperative work amounts of a predetermined past schedule of the user from the schedule management system 3 (S22). Specifically, the learning unit 531 transmits a request for acquiring (one or more) past cooperative work amounts of the predetermined user to the schedule management system 3 via the network N. In response to the acquisition request, the schedule management system 3 acquires a task list in a plurality of time slots corresponding to a predetermined user from the history of the past schedule, and returns the task list to the telework effect prediction system 5. The learning unit 531 classifies each task into either individual work or cooperative work from the acquired task list, and calculates, as the cooperative work amount, the degree of overlap of the tasks in the scheduled execution time slot classified into the cooperative work.

Next, the learning unit 531 acquires a questionnaire result for the past telework effect created by the user (S23). For example, the learning unit 531 receives an input of the questionnaire result in a plurality of time slots from the user terminal 6 via the network N. Here, the questionnaire result corresponds to the “evaluation information about the degree of effectiveness of teleworking” described above. The processing sequence of Steps S21 to S23 is not limited to this.

After that, the learning unit 531 normalizes the congestion rate, the cooperative work amount, and the questionnaire result (S24). That is, the learning unit 531 normalizes each congestion rate in the plurality of time slots with 200% as a reference value (for example, “1.0”), and defines each value as the congestion degree. The learning unit 531 normalizes each cooperative work amount in the plurality of time slots with “6” as a maximum value, and each value is used as the workload. The learning unit 531 normalizes each questionnaire result in a plurality of time slots with “10” as the maximum value, and each value is used as a target value.

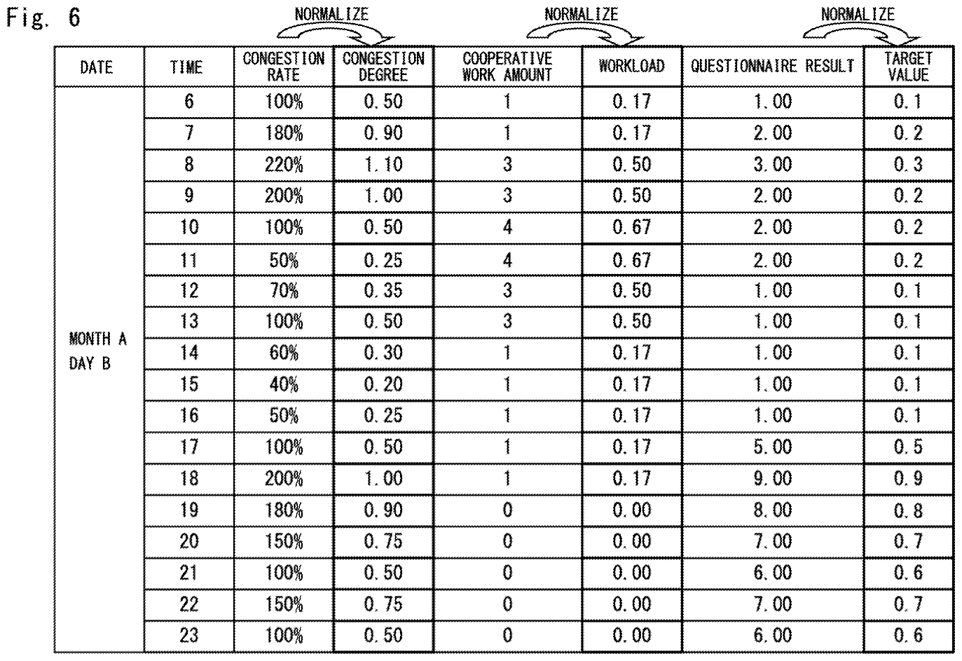

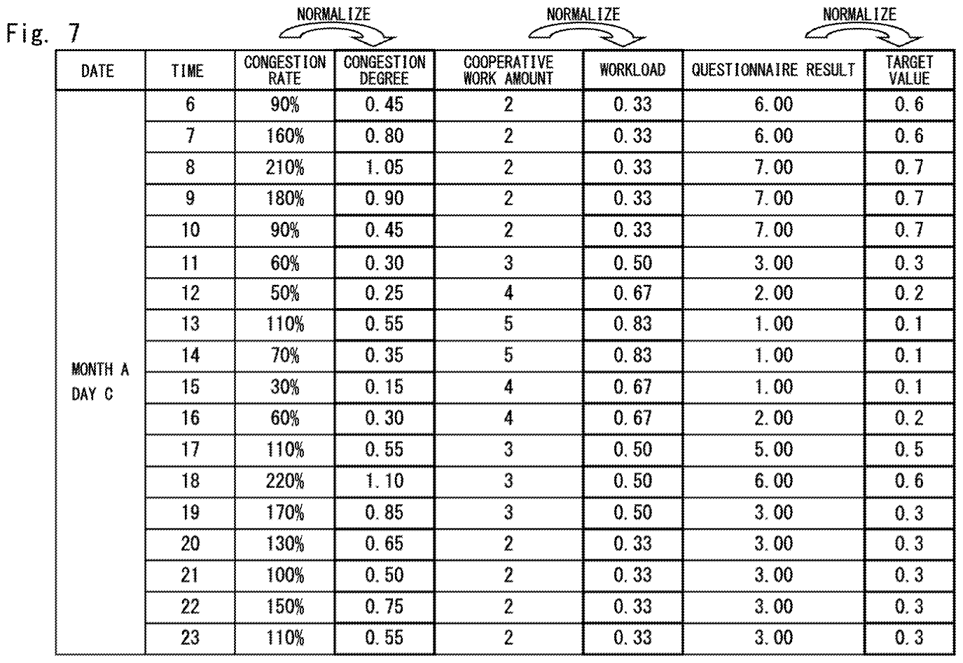

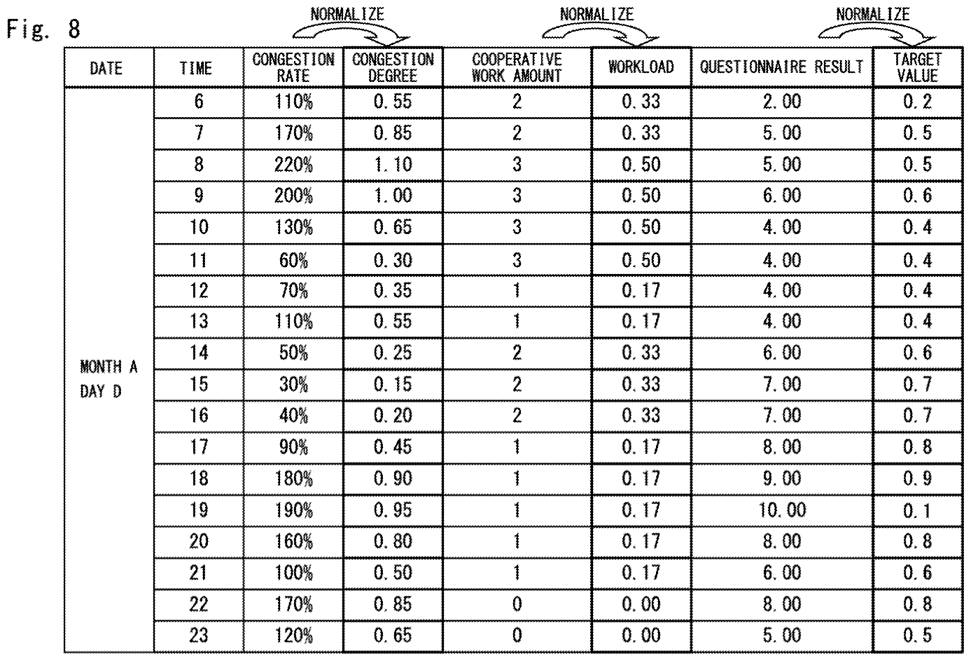

As described above, the learning data of the telework effect prediction model 513 can be generated in Steps S21 to S24. That is, the learning data is a data set of the congestion degree, the workload, and the target value for each time slot. FIGS. 6 to 8 are diagrams showing examples of the learning data according to the second example embodiment. Here, a relationship between the congestion rate, the congestion degree, the cooperative work amount, the workload, the questionnaire result, and the target value are shown for each hour from 6:00 to 23:00 on different dates.

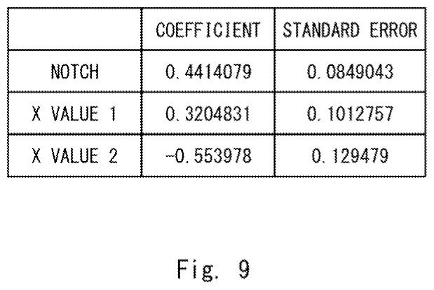

Next, the learning unit 531 inputs the normalized congestion rate (congestion degree) and the normalized cooperative work amount (workload), and performs a multiple regression analysis with the normalized congestion rate (congestion degree) and the normalized cooperative work amount (workload) as input and the normalized questionnaire result (target value) as output to calculate multiple regression parameters (S25). FIG. 9 shows an example of multiple regression parameters according to the second example embodiment. The learning unit 531 sets the calculated multiple regression parameters in the telework effect prediction model 513 and stores the telework effect prediction model 513 in the storage unit 51.

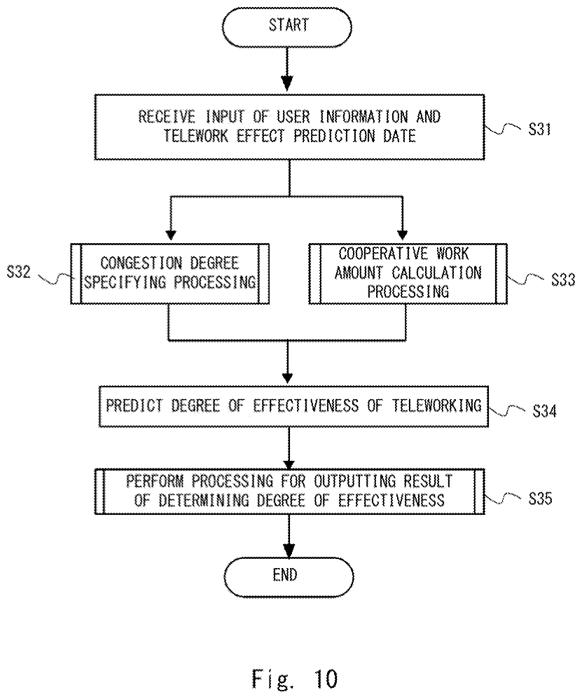

FIG. 10 is a flowchart showing a flow of the telework effect prediction method according to the second example embodiment. First, the telework effect prediction system 5 receives an input of user information and a telework effect prediction date (S31). Specifically, the user terminal 6 receives the user information such as identification information of a specific user and a telework effect prediction date (hereinafter referred to as “designated date”) by an input of the user, and transmits the user information and the designated date to the telework effect prediction system 5 via the network N. In response, the control unit 53 of the telework effect prediction system 5 receives the user information and the designated date. In other words, the telework effect prediction system 5 receives the request for predicting the degree of effectiveness of teleworking from the user terminal 6.

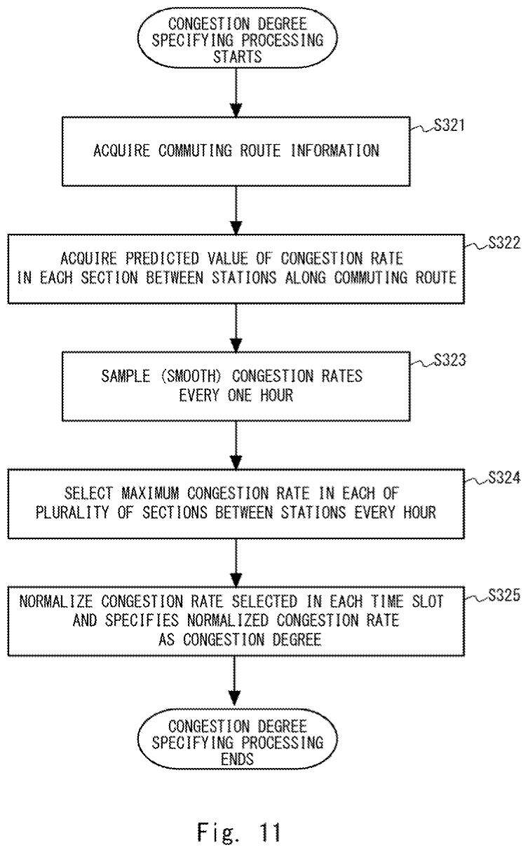

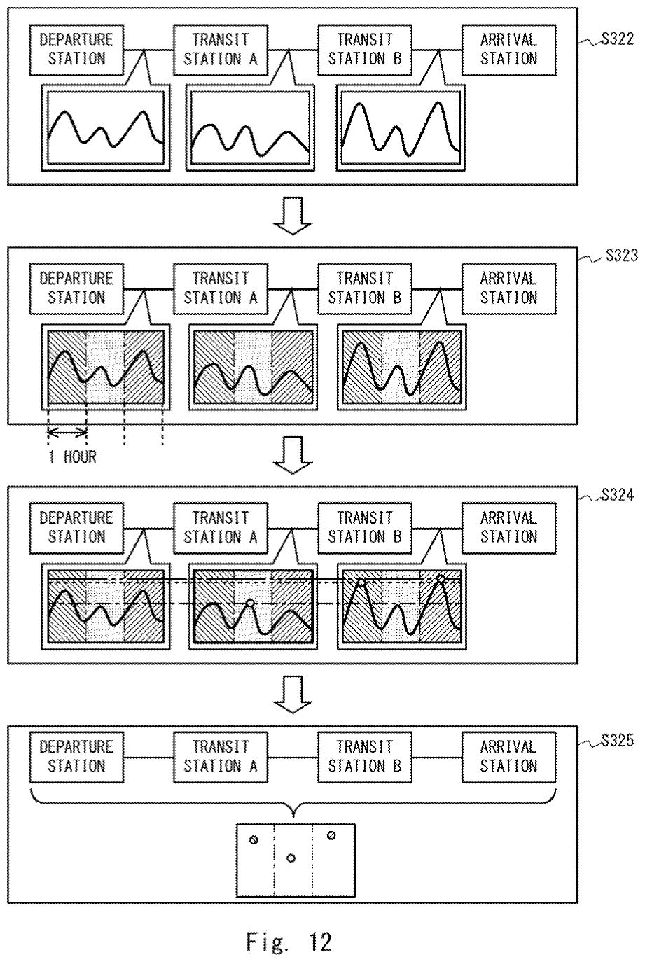

Next, the specifying unit 532 performs congestion degree specifying processing (S32). FIG. 11 is a flowchart showing a flow of the congestion degree specifying processing according to the second example embodiment. FIG. 12 is a diagram for explaining the concept of specifying the congestion degree according to the second example embodiment. Hereinafter, a description will be made with reference to FIG. 11, and a reference will be made to FIG. 12 as appropriate.

First, the specifying unit 532 acquires commuting route information (S321). Specifically, the specifying unit 532 transmits a request for acquiring the commuting route information to the employee information management system 2 via the network N. The specifying unit 532 includes, in the acquisition request, the user information received in Step S31. In response, as described above, the employee information management system 2 specifies the commuting route information in the user information included in the acquisition request, and returns the specified commuting route information to the telework effect prediction system 5 via the network N. In this manner, the specifying unit 532 acquires the commuting route information in the received user information.

Next, the specifying unit 532 acquires a predicted value of the congestion rate in each section between stations along the commuting route (S322). Specifically, the specifying unit 532 transmits a request for acquiring the predicted value of the congestion rate including the designated date received in Step S31 and the commuting route acquired in Step S321 to the route operation result management and operation time prediction system 1 via the network N. In response, the route operation result management and operation time prediction system 1 calculates the predicted value of the congestion rate on the designated date along the commuting route included in the acquisition request based on the past congestion rate. At this time, the route operation result management and operation time prediction system 1 divides the commuting route into a plurality of sections (between stations) and calculates the predicted value (time-series transition) of the congestion rate of the vehicle for each section between stations. The route operation result management and operation time prediction system 1 returns the calculated predicted value of the congestion rate to the telework effect prediction system 5 via the network N. In this way, the specifying unit 532 acquires the predicted value of the congestion rate on the designated date along the commuting route of the specific user. In the example of S322 in FIG. 12, it is shown that the predictions of the time transitions of the congestion rates between a departure station and a transit station A, between the transit station A and a transit station B, and between the transit station B and an arrival station are acquired. Note that the route operation result management and operation time prediction system 1 does not need to calculate the congestion rate in real time in response to the acquisition request, and instead may sequentially calculate and hold the predicted congestion rates in batch processing at a preset timing.

Next, the specifying unit 532 samples (smoothes) the congestion rates every one hour for each section between stations (S323). Specifically, the specifying unit 532 divides the time-series transition of the acquired congestion rate in the section between stations into a range of predetermined time slots (for example, one hour). In the example of S323 in FIG. 12, the time-series transition of the congestion rate in each section between stations is divided into three by one hour. Note that the “predetermined range” is not limited to one hour and may be changed by changing a configuration. The specifying unit 532 smoothes the congestion rates in the sections between stations for each time slot. For example, the specifying unit 532 averages the congestion rates in each time slot divided between the departure station and the transit station A. Alternatively, the specifying unit 532 sets the maximum congestion rate in each time slot as the congestion rate in that time slot. Note that the specifying unit 532 may average or remove a congestion rate that is significantly different from other congestion rates in each time slot.

After that, the specifying unit 532 selects the maximum congestion rate in each of the plurality of sections between stations every hour (S324). That is, the specifying unit 532 compares smoothed congestion rates across the sections between stations for each time slot, and selects the highest congestion rate among them. In other words, the specifying unit 532 selects the maximum congestion rate among the congestion rates in the same time slot in the sections between stations, and sets the selected maximum congestion rate as the congestion rate of this time slot. In the example of S324 in FIG. 12, the (smoothed) congestion rate between the transit station B and the arrival station is selected in the first time slot and the third time slot, and the congestion rate between the transit station A and the transit station B is selected in the second time slot.

Next, the specifying unit 532 normalizes the congestion rate selected in each time slot and specifies the normalized congestion rate as the congestion degree (S325). For example, the specifying unit 532 normalizes the value of each congestion rate from 0% to 200% so that the congestion rate falls within the range of 0 to 1, and defines the normalized value as the congestion degree. Thus, if the congestion degree is 220%, the congestion degree is calculated to be 1.1. In this case, the maximum value of normalization may be called 200%. The maximum value of normalization is not limited to 200%, and may be changed by changing a configuration.

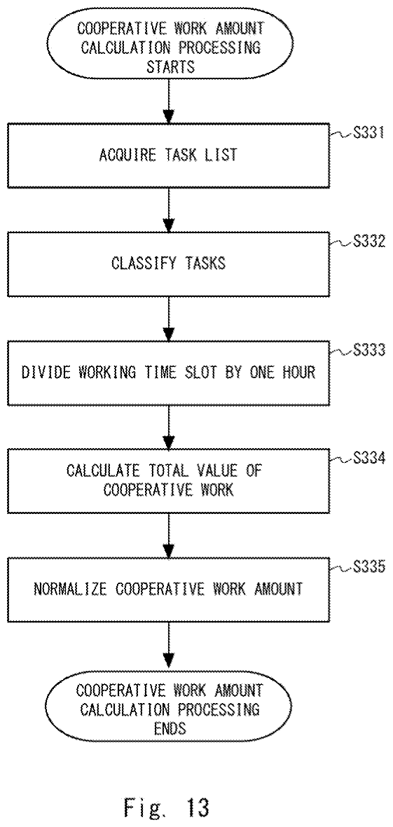

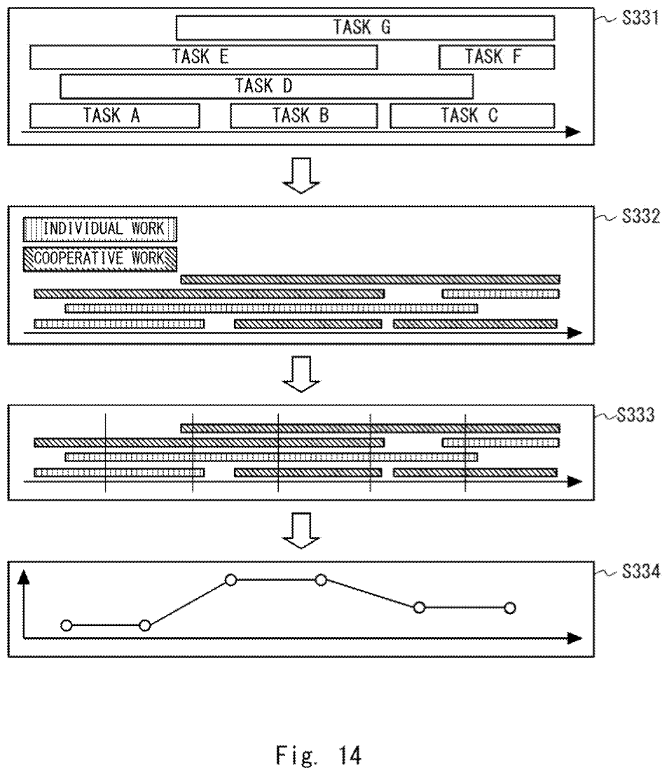

Returning to FIG. 10, the description will be continued. After Step S31, the specifying unit 532 performs cooperative work amount calculation processing (S33). FIG. 13 is a flowchart showing a flow of the cooperative work amount calculation processing according to the second example embodiment. FIG. 14 is a diagram for explaining the concept of the cooperative work amount calculation according to the second example embodiment. Hereinafter, a description will be made with reference to FIG. 13, and a reference will be made to FIG. 14 as appropriate.

First, the calculation unit 533 acquires the task list from the schedule management system 3 (S331). Specifically, the calculation unit 533 transmits a request for acquiring the task list to the schedule management system 3 via the network N. Here, the calculation unit 533 includes the user information received in Step S31 and the designated date in the acquisition request. However, if the user information required to access the schedule management system 3 is insufficient, the calculation unit 533 requests the employee information management system 2 in advance to acquire detailed user information from the user information received in Step S31.

When the schedule management system 3 receives the request for acquiring the task list from the telework effect prediction system 5, the schedule management system 3 specifies the task list associated with the user information included in the acquisition request as described above. The schedule management system 3 returns the specified task list to the telework effect prediction system 5 via the network N. In this manner, the calculation unit 533 acquires the received user information and the task list on the designated date. In the example of S331 in FIG. 14, it is shown that some of tasks A to G overlap each other in a certain period of time.

Next, the calculation unit 533 classifies each task in the task list into either individual work or cooperative work (S332). For example, if the type or content of the task is coding a program or creating documents, the task is classified as the individual work. On the other hand, when the type or content of the task is a meeting or a customer visit, the task is classified as the cooperative work. In the example of S332 in FIG. 14, it is shown that the above-described tasks A to G are classified as either individual work or cooperative work.

Next, the calculation unit 533 divides the working time slot by one hour (S333). For example, the calculation unit 533 divides the period from 6:00 to 24:00 on the designated date into time slots in units of one hour. In the example of S333 in FIG. 14, the working time slot is divided into six. The unit of time slot used to divide the working time slot is not limited to one hour, and may be changed by changing a configuration.

After that, the calculation unit 533 calculates a total value of the cooperative work for each time slot (S334). That is, the calculation unit 533 totals the number of tasks classified as cooperative work for each time slot. In the example of S334 in FIG. 14, since three cooperative works overlap each other in the third time slot from the left, the total value is calculated as 3.

Next, the calculation unit 533 normalizes the cooperative work amount for each time slot (S335). For example, the calculation unit 533 normalizes the cooperative work amount in each time slot with “6” as the maximum value, and sets each value as the workload. The maximum value of the cooperative work amount is not limited to 6, and may be changed by changing a configuration.

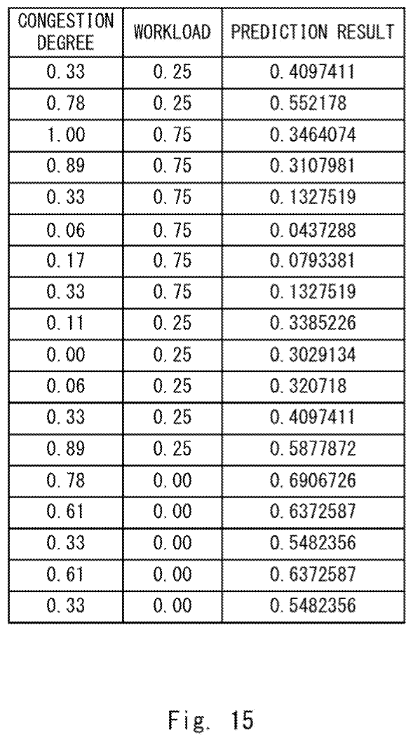

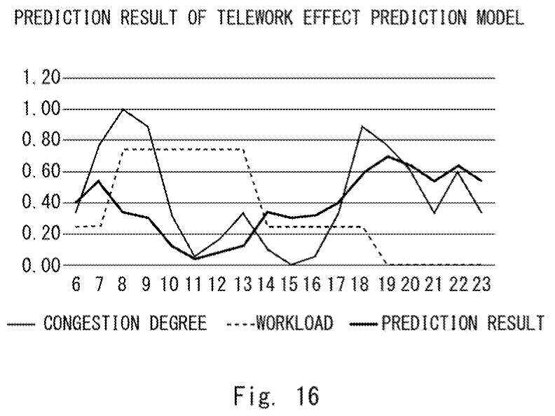

Returning to FIG. 10, the description will be continued. After Steps S32 and S33, the prediction unit 534 predicts the degree of effectiveness of teleworking (S34). Specifically, as described above, the prediction unit 534 inputs the congestion degree specified in the Step S32 and the workload calculated in the Step S33 to the telework effect prediction model 513, and acquires the output result as the degree of effectiveness of teleworking. FIG. 15 shows an example of a prediction result (degree of effectiveness) based on the congestion degree and the workload according to the second example embodiment. FIG. 16 shows an example of a graph display of the congestion degree, the workload, and the prediction result (degree of effectiveness) according to the second example embodiment.

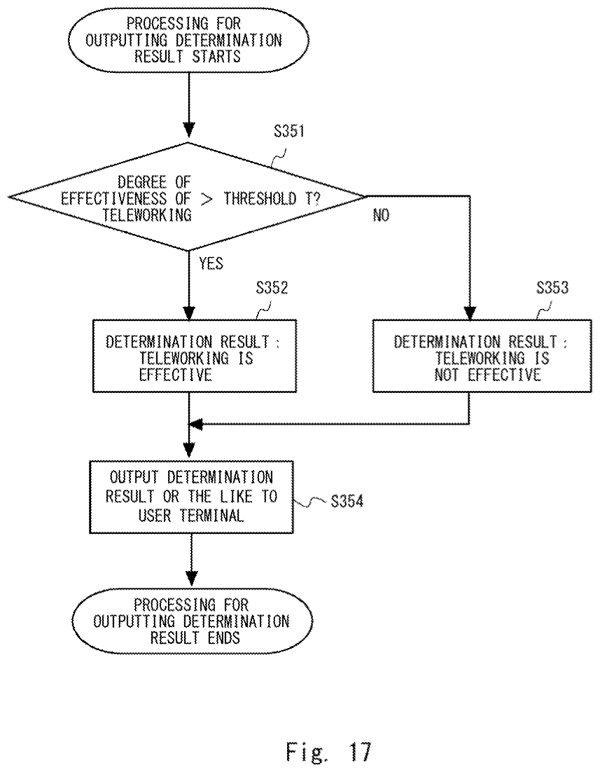

After that, the output unit 535 performs processing for outputting a result of determining the degree of effectiveness (S35). FIG. 17 is a flowchart showing the flow of the processing for outputting the determination result according to the second example embodiment. First, the output unit 535 determines whether the degree of effectiveness of teleworking in each time slot is greater than a threshold T (S351). Here, the threshold T is set to, for example, 0.5. Therefore, when the degree of effectiveness of teleworking is greater than 0.5, the output unit 535 sets the effectiveness of teleworking as the determination result (S352). On the other hand, when the degree of effectiveness of teleworking is 0.5 or less, the output unit 535 sets, in the determination result, that the telework is not effective (S353). Steps S351 to S353 may be repeated for each time slot.

After Step S352 or S353, the output unit 535 outputs the determination result or the like to the user terminal 6 (Step S354). That is, the output unit 535 transmits the determination result and the degree of effectiveness for each time slot to the user terminal 6 via the network N. In response, the user terminal 6 displays the received determination result and degree of effectiveness for each time slot on the screen. The output unit 535 may output a graph as shown in FIG. 16 to the user terminal 6 via the network N and display it on a screen of the user terminal 6.

As described above, the user using the user terminal 6 can understand, by an objective index, whether or not it is effective to perform teleworking in each time slot for the specific user input in Step S31 on the designated date. Thus, the teleworking can be performed at more appropriate timing. This can contribute to the spread and promotion of teleworking.

As described above, since there is currently no quantitative index of whether teleworking is effective, it has not been possible to determine whether teleworking should be implemented in the future based on criteria other than subjective criteria. Here, it can be said that the index of the effectiveness of teleworking has a correlation with traffic congestion in commuting hours and work contents, such that, for example, the higher the congestion rate of commuter trains, the higher the index of the telework effectiveness becomes, and the more the number of tasks that require cooperative work, the lower the lower index of the telework effectiveness becomes. Therefore, in this example embodiment, by using the telework effect prediction model 513, it is possible to quantitatively predict the degree of effectiveness of teleworking in the future.

### Third Example Embodiment

A third example embodiment is an improved example of the second example embodiment. Here, the prediction of the degree of effectiveness of teleworking is made for a case when a specific user can select a plurality of commuting routes. For example, as one of the plurality of commuting routes, there may be a detour route in addition to a usual route to the nearest station of a workplace. Alternatively, as one of the plurality of commuting routes, if there is a satellite office other than the usual office, there may be a route to the station nearest to the satellite office designated as an arrival station. The telework effect prediction system and the peripheral system according to the third example embodiment are not shown, because they are the same as those in FIG. 3, and the configuration diagram of the telework effect prediction system 5 is the same as that in FIG. 4. Hereinafter, the configuration and processing specific to the third example embodiment will be mainly described.

When there are a plurality of commuting routes of the specific user on the designated date, the specifying unit 532 according to the third example embodiment acquires a plurality of predicted values for the respective commuting routes. When the plurality of predicted values are acquired, the prediction unit 534 according to the third example embodiment predicts a plurality of degrees of effectiveness for the respective commuting routes. The output unit 535 according to the third example embodiment sorts the plurality of predicted degrees of effectiveness and outputs information based on the sorted degrees of effectiveness. By doing so, the specific user can select a more appropriate commuting route to commute. For example, a route when the satellite office is used may also be shown, which may result in promoting teleworking.

Further, the output unit 535 outputs a commuting route having a degree of effectiveness lower than a predetermined value among the sorted degree of effectiveness. Thus, when the degree of effectiveness of teleworking is low, by selecting an appropriate commuting route to commute, the tasks at the office can be performed more appropriately.

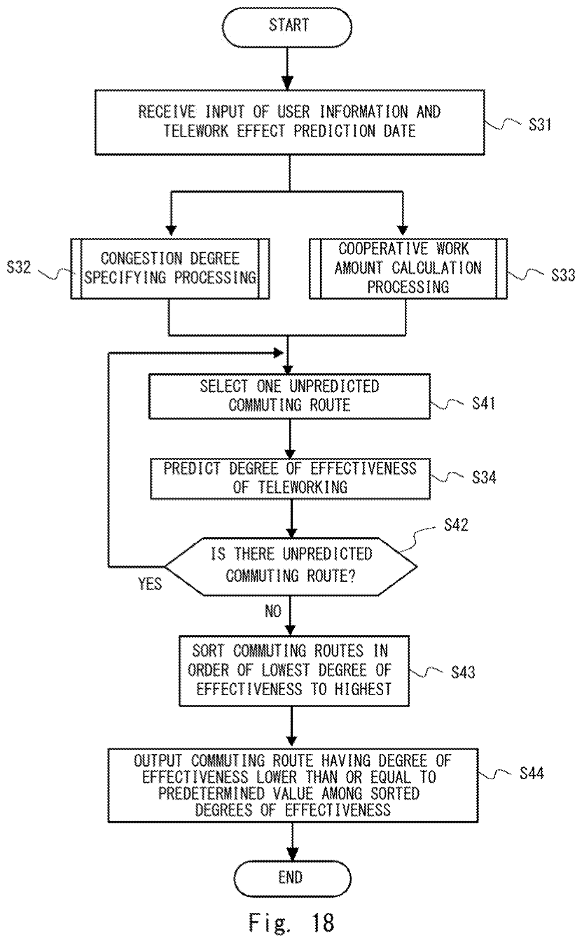

FIG. 18 is a flowchart showing a flow of a telework effect prediction method according to the third example embodiment. Here, processing similar to that of FIG. 10 described above will not be described.

First, in Step S32, it is assumed that there are a plurality of commuting routes of a specific user on a designated date. In this case, the specifying unit 532 acquires a plurality of predicted values for the respective commuting routes and specifies the congestion degree for each commuting route.

After Steps S32 and S33, the prediction unit 534 selects one unpredicted commuting route (Step S41). Then, the prediction unit 534 predicts the degree of effectiveness of teleworking for the selected commuting route (S34). After that, the prediction unit 534 determines whether or not there is an unpredicted commuting route (Step S42). If it is determined that there is an unpredicted commuting route, the prediction unit 534 repeats Steps S41, S34, and S42.

On the other hand, if it is determined in Step S42 that there is no unpredicted commuting route, the output unit 535 sorts the commuting routes in order of the lowest degree of effectiveness to the highest (Step S43). After that, the output unit 535 outputs a commuting route having a degree of effectiveness lower than or equal to a predetermined value among the sorted degrees of effectiveness (S44). For example, the output unit 535 transmits the sorted degrees of effectiveness to the user terminal 6 via the network N. Alternatively, the output unit 535 transmits a commuting route having a degree of effectiveness of a predetermined value or less to the user terminal 6 via the network N. In response, the user terminal 6 displays the sorted degrees of effectiveness of the received commuting route on the screen.

### Fourth Example Embodiment

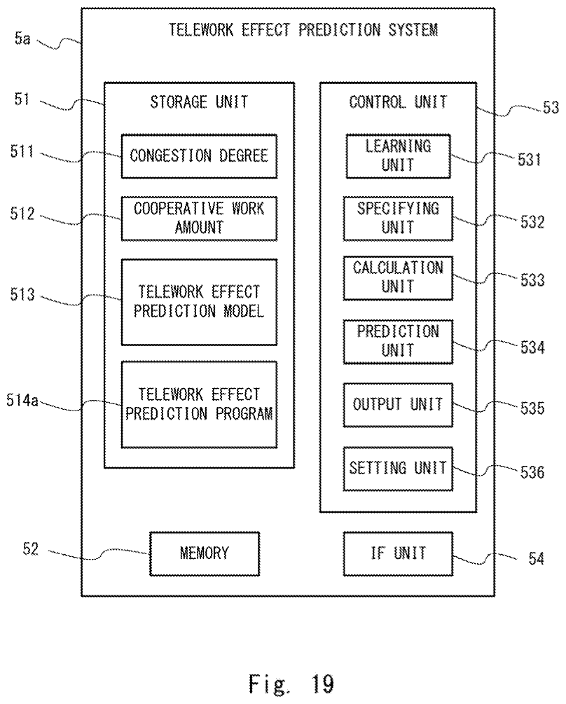

A fourth example embodiment is an improved example of the second or third example embodiment described above. The fourth example embodiment is an automatic setting method for a teleconference. FIG. 19 is a block diagram showing a configuration of a telework effect prediction system 5a according to the fourth example embodiment. The telework effect prediction system 5a further includes a setting unit 536 in addition to the components of the telework effect prediction system 5 described above and includes a telework effect prediction program 514a in place of the telework effect prediction program 514. The configuration other than these components is the same as that according to the second example embodiment, and thus the description of the same components is omitted.

The setting unit 536 sets a specific user as a participant of a teleconference when the degree of effectiveness calculated by the calculation unit 533 is higher than a predetermined value and cooperative work is scheduled in a time slot corresponding to this degree of effectiveness. The telework effect prediction program 514a is a computer program in which, in addition to the telework effect prediction method according to the second or third example embodiment, teleconference setting processing described later is implemented.

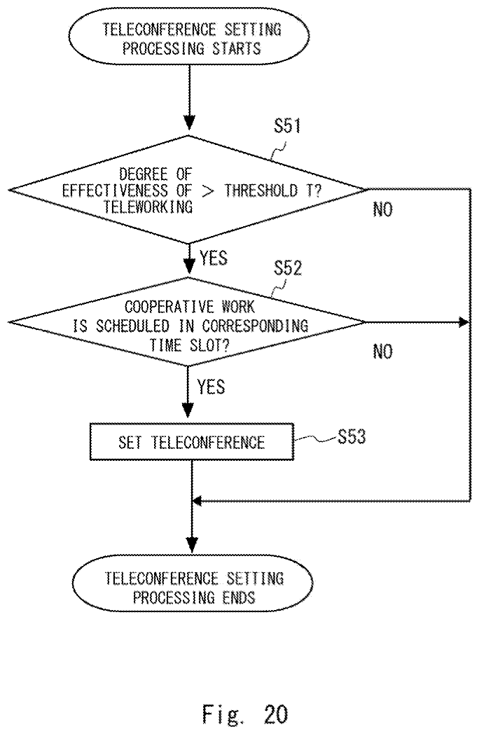

FIG. 20 is a flowchart showing a flow of the teleconference setting processing according to the fourth example embodiment. For example, it is assumed that the degree of effectiveness has been predicted in Step S34 in FIG. 10. The teleconference setting processing may be executed in parallel or independently of the output processing in Step S35.

First, the setting unit 536 determines whether the degree of effectiveness of teleworking in each time slot is greater than a threshold T (S51). If the degree of effectiveness of teleworking is greater than the threshold T, the setting unit 536 determines whether or not cooperative work is scheduled in the corresponding time slot (S52). When the cooperative work is scheduled in the corresponding time slot, the setting unit 536 sets the specific user as a participant of the teleconference (S53). For example, the setting unit 536 transmits a teleconference setting request to the schedule management system 3 via the network N. In this case, the configuration request includes the specific user as a participant of the teleconference. If it is determined NO in Step S51 or S52, the processing ends.

As described above, in the fourth example embodiment, the degree of effectiveness of teleworking is predicted as described above. When teleworking is determined to be effective and when cooperative work scheduled in a time slot when teleworking is determined to be effective is a conference, a new teleconference is automatically set. This can promote the use of teleconferencing.

### Other Example Embodiment

Each of the above-described example embodiments may be utilized as a new added value in the technical field of providing train congestion information or in the technical field of providing business management technology.

Although the above example embodiments have been described as a hardware configuration, it is not limited thereto. The present disclosure may also be implemented by causing a CPU to execute a computer program.

In the above example, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Note that the present disclosure is not limited to the above-described example embodiments, and may be modified as appropriate without departing from the spirit thereof. Further, the present disclosure may be carried out by appropriately combining the respective example embodiments.

The whole or part of the example embodiments disclosed above can be described as, but not limited to, the following supplementary notes.

### (Supplementary Note A1)

A telework effect prediction apparatus comprising:

storage means for storing a telework effect prediction model for predicting a degree of effectiveness of teleworking based on a congestion degree of a commuting route and a cooperative work amount of a user;

acquisition means for acquiring a predicted value of the congestion degree of the commuting route of a specific user on a designated date;

calculation means for calculating a cooperative work amount from a work schedule of the specific user on the designated date;

prediction means for predicting the degree of effectiveness of the teleworking from the acquired predicted value and the calculated cooperative work amount by using the telework effect prediction model; and

output means for outputting information based on the predicted degree of effectiveness.

### (Supplementary Note A2)

The telework effect prediction apparatus according to Supplementary note A1, further comprising:

learning means for learning the telework effect prediction model by using a past congestion rate in each commuting route of a plurality of users, the cooperative work amount on each past working day of each of the plurality of users, and evaluation information about the degree of effectiveness of the teleworking on the working day of each of the plurality of users.

### (Supplementary Note A3)

The telework effect prediction apparatus according to Supplementary note A1 or A2, wherein

the output means outputs a determination result for the predicted degree of effectiveness.

### (Supplementary Note A4)

The telework effect prediction apparatus according to any one of Supplementary notes A1 to A3, wherein

the output means outputs information based on the predicted degree of effectiveness according to a time slot on the designated date.

### (Supplementary Note A5)

The telework effect prediction apparatus according to any one of Supplementary notes A1 to A4, wherein

when there are a plurality of the commuting routes of the specific user on the designated date, the acquisition means acquires a plurality of the predicted values corresponding to the respective commuting routes, and

when the plurality of the predicted values are acquired, the prediction means predicts a plurality of the degrees of effectiveness corresponding to the respective plurality of the commuting routes, and

the output means sorts the plurality of the predicted degrees of effectiveness and outputs information based on the sorted degrees of effectiveness.

### (Supplementary Note A6)

The telework effect prediction apparatus according to Supplementary note A5, wherein

the output means outputs the commuting route having the degree of effectiveness lower than a predetermined value among the sorted degrees of effectiveness.

### (Supplementary Note A7)

The telework effect prediction apparatus according to any one of Supplementary notes A1 to A6, further comprising:

a setting unit configured to set the specific user as a participant of a teleconference when the calculated degree of effectiveness is higher than the predetermined value and cooperative work is scheduled in the time slot corresponding to the degree of effectiveness.

### (Supplementary Note B1)

A telework effect prediction method performed by a computer comprising: acquiring a predicted value of a congestion degree of a commuting route of a specific user on a designated date;

calculation means for calculating a cooperative work amount from a work schedule of the specific user on the designated date;

predicting a degree of effectiveness of teleworking from the acquired predicted value and the calculated cooperative work amount by using a telework effect prediction model for predicting the degree of effectiveness of the teleworking based on the congestion degree of the commuting route and the cooperative work amount of a user; and

outputting information based on the predicted degree of effectiveness.

### (Supplementary Note C1)

A non-transitory computer readable medium storing a telework effect prediction program for causing a computer to execute:

processing of acquiring a predicted value of a congestion degree of a commuting route of a specific user on a designated date;

processing of calculation means for calculating a cooperative work amount from a work schedule of the specific user on the designated date;

processing of predicting a degree of effectiveness of teleworking from the acquired predicted value and the calculated cooperative work amount by using a telework effect prediction model for predicting the degree of effectiveness of the teleworking based on the congestion degree of the commuting route and the cooperative work amount of a user; and

processing of outputting information based on the predicted degree of effectiveness.

Although the present disclosure has been described with reference to example embodiments (and examples), the present disclosure is not limited to the above embodiments (and examples). The configuration and details of the present disclosure may be modified in various ways that will be understood by those skilled in the art within the scope of the present disclosure.

### REFERENCE SIGNS LIST

100 TELEWORK EFFECT PREDICTION APPARATUS
110 STORAGE UNIT
111 TELEWORK EFFECT PREDICTION MODEL
120 ACQUISITION UNIT
130 CALCULATION UNIT
140 PREDICTION UNIT
150 OUTPUT UNIT
1 ROUTE OPERATION RESULT MANAGEMENT AND OPERATION TIME PREDICTION SYSTEM
2 EMPLOYEE INFORMATION MANAGEMENT SYSTEM
3 SCHEDULE MANAGEMENT SYSTEM
4 ROUTE SEARCH SYSTEM
5 TELEWORK EFFECT PREDICTION SYSTEM
5a TELEWORK EFFECT PREDICTION SYSTEM
STORAGE UNIT
511 CONGESTION DEGREE
512 COOPERATIVE WORK AMOUNT
513 TELEWORK EFFECT PREDICTION MODEL
514 TELEWORK EFFECT PREDICTION PROGRAM
514a TELEWORK EFFECT PREDICTION PROGRAM
52 MEMORY
53 CONTROL UNIT
531 LEARNING UNIT
532 SPECIFYING UNIT
533 CALCULATION UNIT
534 PREDICTION UNIT
535 OUTPUT UNIT
536 SETTING UNIT
54 IF UNIT
6 USER TERMINAL
N NETWORK

What is claimed is:

1. A telework effect prediction apparatus comprising:
at least one storage device configured to store instructions and a telework effect prediction model for predicting a degree of effectiveness of teleworking based on a congestion degree of a commuting route and a cooperative work amount of a user; and
at least one processor configured to execute the instructions to:
acquire a predicted value of the congestion degree of the commuting route of a specific user on a designated date;
calculate a cooperative work amount from a work schedule of the specific user on the designated date;
predict the degree of effectiveness of the teleworking from the acquired predicted value and the calculated cooperative work amount by using the telework effect prediction model; and
output information based on the predicted degree of effectiveness.

2. The telework effect prediction apparatus according to claim 1, wherein the at least one processor is further configured to execute the instructions to:
learn the telework effect prediction model by using a past congestion rate in each commuting route of a plurality of users, the cooperative work amount on each past working day of each of the plurality of users, and evaluation information about the degree of effectiveness of the teleworking on the working day of each of the plurality of users.

3. The telework effect prediction apparatus according to claim 1, wherein the at least one processor is further configured to execute the instructions to:
output a determination result for the predicted degree of effectiveness.

4. The telework effect prediction apparatus according to claim 1, wherein the at least one processor is further configured to execute the instructions to:
output information based on the predicted degree of effectiveness according to a time slot on the designated date.

5. The telework effect prediction apparatus according to claim 1, wherein the at least one processor is further configured to execute the instructions to:
when there are a plurality of the commuting routes of the specific user on the designated date, acquire a plurality of the predicted values corresponding to the respective commuting routes, and
when the plurality of the predicted values are acquired, predict a plurality of the degrees of effectiveness corresponding to the respective plurality of the commuting routes, and
sort the plurality of the predicted degrees of effectiveness and output information based on the sorted degrees of effectiveness.

6. The telework effect prediction apparatus according to claim 5, wherein the at least one processor is further configured to execute the instructions to:
output the commuting route having the degree of effectiveness lower than a predetermined value among the sorted degrees of effectiveness.

7. The telework effect prediction apparatus according to claim 1, wherein the at least one processor is further configured to execute the instructions to:
set the specific user as a participant of a teleconference when the calculated degree of effectiveness is higher than the predetermined value and cooperative work is scheduled in the time slot corresponding to the degree of effectiveness.

8. A telework effect prediction method performed by a computer comprising:
acquiring a predicted value of a congestion degree of a commuting route of a specific user on a designated date;
calculation means for calculating a cooperative work amount from a work schedule of the specific user on the designated date;
predicting a degree of effectiveness of teleworking from the acquired predicted value and the calculated cooperative work amount by using a telework effect prediction model for predicting the degree of effectiveness of the teleworking based on the congestion degree of the commuting route and the cooperative work amount of a user; and
outputting information based on the predicted degree of effectiveness.

9. A non-transitory computer readable medium storing a telework effect prediction program for causing a computer to execute:
processing of acquiring a predicted value of a congestion degree of a commuting route of a specific user on a designated date;
processing of calculation means for calculating a cooperative work amount from a work schedule of the specific user on the designated date;
processing of predicting a degree of effectiveness of teleworking from the acquired predicted value and the calculated cooperative work amount by using a telework effect prediction model for predicting the degree of effectiveness of the teleworking based on the congestion degree of the commuting route and the cooperative work amount of a user; and
processing of outputting information based on the predicted degree of effectiveness.
